(19) United States
(12) Patent Application Publication
(10) Pub. No.: US 2022/0046303 A1
(43) Pub. Date: Feb. 10, 2022

(54) System And Method For Delivering AV Content

(71) Applicant: Edge Networks, Inc., Sun Valley, ID (US)

(72) Inventors: Imran Maskatia, Palo Alto, CA (US); Todd Achilles, Sun Valley, ID (US)

(73) Assignee: Edge Networks, Inc., Sun Valley, ID (US)

(21) Appl. No.: 17/377,373

(22) Filed: Jul. 15, 2021

Related U.S. Application Data
(63) Continuation-in-part of application No. 16/664,808, filed on Oct. 26, 2019, now abandoned.
(60) Provisional application No. 62/831,136, filed on Apr. 8, 2019.

(51) Int. Cl. H04N 21/258

(52) U.S. Cl. CPC H04N 21/25891

(57) ABSTRACT

A method of communicating audiovisual (AV) content to a viewer, the method includes: determining viewing preferences associated with a viewer, communicating the preferences to a content controller, identifying data files corresponding to the preferences by the content controller, communicating, by the content controller, a manifest to the user wherein the manifest identifies the data files that are to be broadcast over the air, receiving, by a tuner associated with the user, the broadcast data files and storing, by a set-top box associated with the tuner, the received broadcast data files.

### RELATED APPLICATIONS/CLAIM FOR PRIORITY

This application is a continuation in part of U.S. application Ser. No. 16/664,808 filed on 26 Oct. 2019 which in turn claims the benefit of the filing date of U.S. Provisional Application No. 62/831,136 filed on Apr. 8, 2019. This application is also related to U.S. patent application Ser. No. 16/578,159 filed on Sep. 20, 2019, U.S. patent application Ser. No. 16/591,767 filed on Oct. 3, 2019 and U.S. patent application Ser. No. 17/370,774 filed on Jul. 8, 2021. The subject matter of each of these applications is incorporated herein in their entirety by reference.

### BACKGROUND

This disclosure is directed to audiovisual (AV) content transmission and more specifically, to caching the content for a viewer.

A recently adapted television standard, ATSC 3.0 (Advanced Television Systems Committee) provides for the broadcast (over the air, OTA) of television signals an internet protocol (IP) format which is the format in which data is communicated over a broadband/internet connection.

OTA interface is a traditional communication path for broadcasting to all receivers within a physical viewing or receiving range. Transmission over a broadband (or network), on the other hand, can take place via unicast (one destination) or multicast (multiple destinations).

Traditional consumer ISPs (Internet service providers), utilizing unicast data networks, are overwhelmed by video streaming traffic. During the peak hours (typically between 5 to 10 PM), video streaming can consume as much as 90% of bandwidth. During non-peak periods, bandwidth is abundant and the marginal cost is effectively zero because ISPs pay by bandwidth rather than aggregate packets sent/received.

Video content distribution companies were traditionally tied to a specific delivery mechanism. Broadcast companies were tied to RF-based (Radio Frequency) broadcasts over antennas. Cable companies were tied to QAM (Quadrature Amplitude Modulation) delivery over HFC (Hybrid Fiber Coaxial) cable. Telephone communication companies used their direct, individual wiring (such as twisted-pair copper wires and later, fiber) to consumers' homes to deliver their content.

Broadcast mechanisms (such as cable, satellite, RF antenna Over-the-Air) require significant up-front investment but then have a significantly reduced cost of delivery as the number of consumers watching a particular program increase.

For any audiovisual (AV) content distribution company, consumer usage patterns tend to ebb and flow. At times, many consumers view lots of programs and at other times, they view fewer programs. Content distribution companies need to plan their distribution capacity according to the peaks of their customers' viewing habits. There will be time periods where their capacity will be unused. In addition, some distribution methods will have metered pricing, and that metered pricing may also have different rates based on the time of day.

What is desired is a system and a method for efficiently delivering AV content using a hybrid of broadcast and unicast methodologies audiovisual content to viewers.

The terms “user”, “viewer”, “customer” and “consumer” are used interchangeably within this disclosure. The terms “AV signals”, “AV content”, “AV program”, “data files” and “broadcast content” are also used interchangeably.

### SUMMARY

According to an example embodiment, a method of communicating audiovisual (AV) content to a viewer comprises: determining viewing preferences associated with a viewer; communicating the preferences to a content controller; identifying data files corresponding to the preferences by the content controller; communicating, by the content controller, a manifest to the user wherein the manifest identifies the data files that are to be broadcast over the air; receiving, by a tuner associated with the user, the broadcast data files; and storing, by a set-top box associated with the tuner, the received broadcast data files.

### BRIEF DESCRIPTION OF THE DRAWINGS

The several features, objects, and advantages of example embodiments will be understood by reading this description in conjunction with the drawings. The same reference numbers in different drawings identify the same or similar elements. In the drawings:

FIG. 1 illustrates a system according to example embodiments;

FIG. 2 illustrates a designated market area (DMA) broadcast system according to example embodiments;

FIG. 3 illustrates a central content controller according to example embodiments;

FIG. 4 illustrates a set-top-box (STB) according to example embodiments; and

FIG. 5 illustrates a method according to example embodiments.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the example embodiments.

Reference throughout this specification to an “example embodiment” or “example embodiments” means that a particular feature, structure, or characteristic as described is included in at least one embodiment. Thus, the appearances of these terms and similar phrases in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the embodiments.

In an example scenario, a viewer may wish to view an AV program at a time of her choosing. According to example embodiments, the AV program may be broadcast over the air (OTA) as a file and stored or cached on a viewer's set-top-box (STB) or in the memory of an application so the viewer can watch the program. The AV content can be broadcast and stored in a memory during time periods that are optimal to the content distribution company. Such stored content may be viewed by the viewer at his leisure.

According to example embodiments, methods and systems are disclosed for communicating audio visual (AV) content to a viewer. Signals corresponding to the AV content may be broadcast over-the-air (OTA) and cached at the viewer premises.

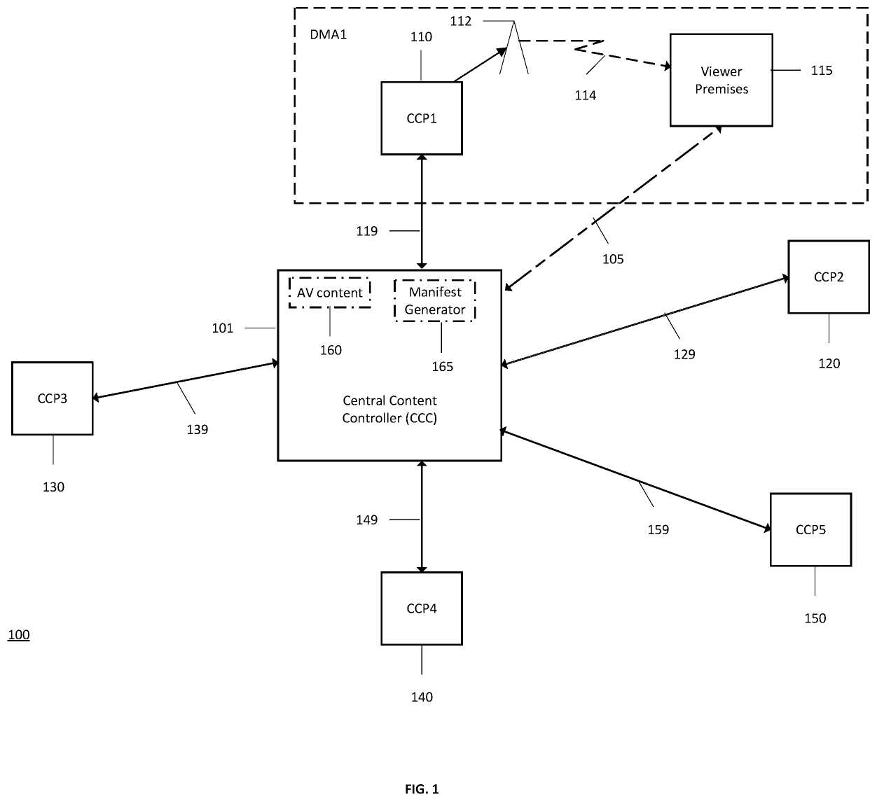

A system in accordance with example embodiments may be described with reference to FIG. 1. System 100 may comprise a central content controller (CCC) 101 and a plurality of content controller proxies (CCPs) 110, 120, 130, 140 and 150. Communication between CCC 101 and each of CCPs 110-150 may be over dedicated networks such as virtual private networks (VPNs 119, 129, 139, 149 and 159 for example).

Each of the CCPs may be associated with a designated market area (DMA). CCP 110 may be associated with DMA1 as illustrated. Each CCP may receive data files and instructions to broadcast the data to the corresponding DMA from CCC 101. That is, a functionality of CCPs 110-150 such as to broadcast within the corresponding DMA may be controlled by CCC 101. Each CCP may provide information such as data receipt acknowledgement to the CCC.

Each of the CCPs may serve a DMA that includes a plurality of user premises. One such user premises 115 is illustrated. CCP1 110 may broadcast audio visual (AV) signals 114 over the air (OTA) using a broadcast tower 112. User premises 115 may receive the broadcast signals 114. User premises 115 may communicate with CCC 101 via network 105 which could be a public network such as the internet.

In some embodiments, AV content files may be stored in one or more content servers 160 located within CCC 101 or at the same location as the CCC; in some embodiments, it can be located apart from or at a different location than CCC 101. Data files (stream of IP packets located at content server 160 for example) sent to CCPs 110-150 for broadcast within the corresponding DMA.

The stream of IP packets may be converted to RF signals by the CCPs for broadcast within the corresponding DMA.

Each of CCPs 110, 120, 130, 140 and 150 may broadcast content that is specific to the corresponding DMA. Such “local” content may be from channels or sources specific to the DMA. As an example, CCP1 110 may correspond to a DMA associated with Boise, ID and may broadcast AV signals for programming that is specific to Boise such as news, weather, sports, school information, traffic, etc. CCP4 140 may correspond to a DMA associated with San Francisco, Calif. and may broadcast AV signals for programming that is specific to San Francisco.

CCC 101 also may include a manifest generator which is described further below. Manifests generated by CCC 101 may be communicated to user premises (such as viewer premises 115) over network 105.

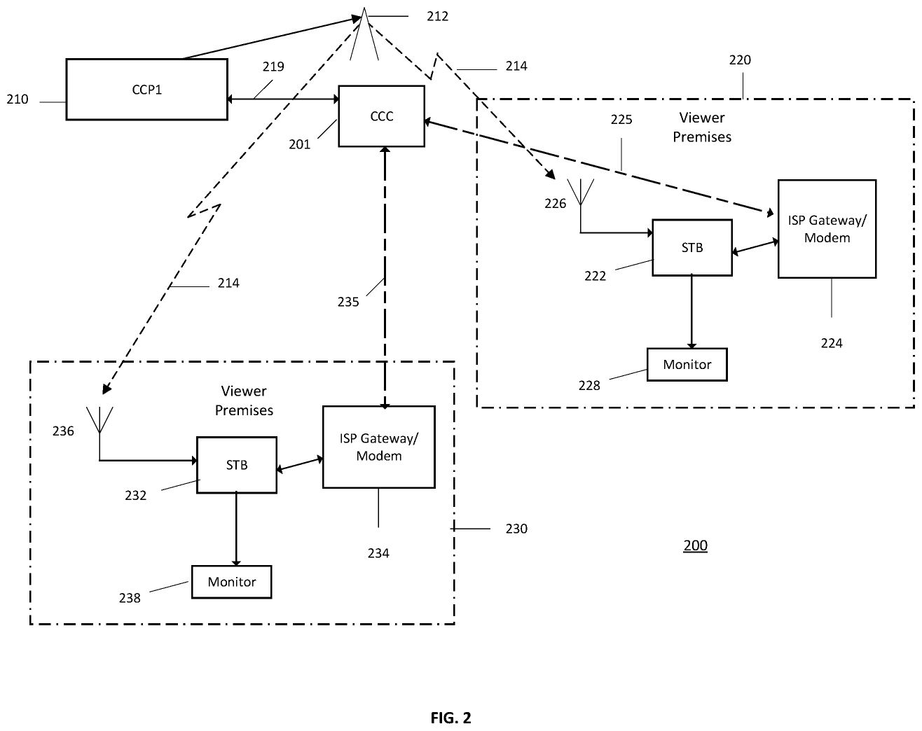

An example system for implementation in a designated market area (DMA) is illustrated in FIG. 2. In system 200, two viewer premises 220 and 230 are shown purely for illustrative purposes—many such premises exist within a typical DMA. In the following description, functionality associated with systems and methods of viewer premises 220 are highlighted. The description can apply similarly to any and all other viewer premises such as premises 230 for example.

System 200 may include a content controller proxy (CCP1) 210 broadcasting over the air (OTA) broadcast signals 214 within a DMA using a broadcast tower/antenna 212. The broadcast signals may be received by any viewer premises having an antenna within the DMA.

Viewer premises 220 may include an antenna 226 for receiving the broadcast AV signals. The AV signals received by the antenna can be processed by a set-top-box (STB) 222. Viewer premises 220 may also include, inter alia, a communication interface 224 and a monitor 228.

AV content may also be communicated as data files via network 205 (similar to network 105 of FIG. 1). The files communicated over network 205 may be received at user premises 220 by communication interface 224.

The data files which may include AV signals received by antenna 226 and received by interface 224 may be processed (decoded, etc.) by STB 222 and stored in a memory associated with the STB. The decoded data may be presented as AV signals, as text and/or interactive content for example on monitor 228.

Data may be communicated by/from STB 222 to CCC 201 via network 225. User interactions/preferences can be communicated by STB 222 for example.

STB 222 of FIG. 2 is depicted as a hardware device purely for illustrative purposes. STB 222 can also be a software application. It can be a software application running on a smart TV for example. Therefore, a set-top-box (STB) as referred to in this disclosure can encompass a hardware and/or a software implementation/version.

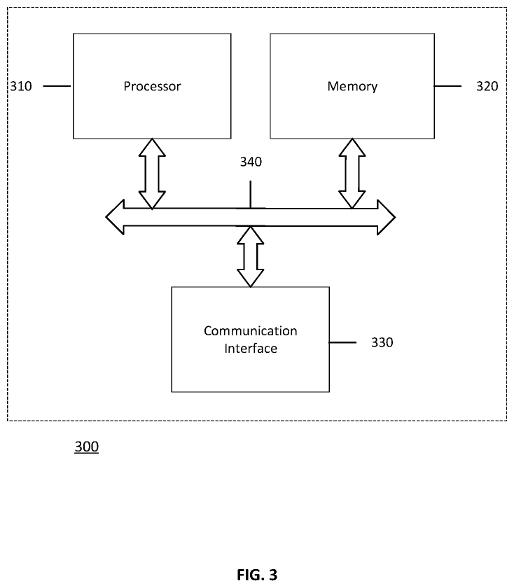

A central content controller (CCC) in accordance with example embodiments is illustrated in FIG. 3. CCC 300 may include, but is not limited to, a processor 310, a memory 320, a communication interface 330 and a system bus 340 for interconnecting each of these components in a known manner. A CCP may comprise similar components as CCC 300 and may be configured similar to CCC 300.

Interface 330 may provide communication between CCC 300 (or CCC 101 of FIG. 1) and the plurality of CCPs in their respective DMAs and STBs 222, 232 (of FIG. 2). The communication between CCC 300 and the CCPs and/or STBs 222, 232 may be via a dedicated private network 119, 129, 139, 149 and 159 (of FIG. 1) or 219 (of FIG. 2).

CCC 300 may have AV content stored within memory 320. In some embodiments, AV content may be archived in multiple locations.

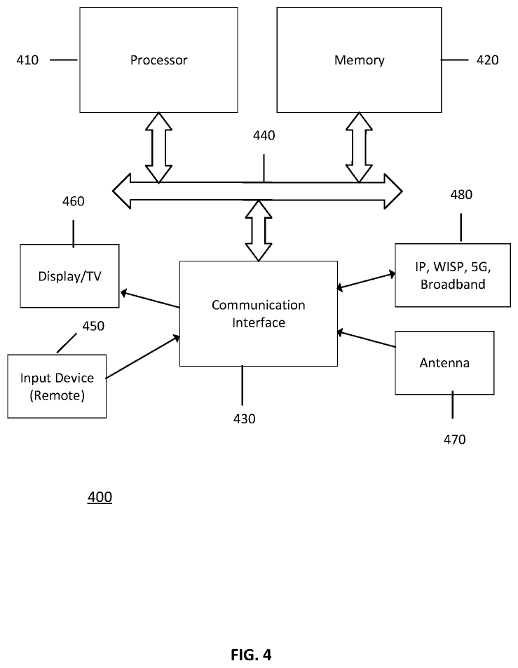

A set-top-box (STB) in accordance with example embodiments is illustrated in FIG. 4. STB 400 (labeled as 222 in FIG. 2) may include, but not limited to, a processor 410, a memory 420, a communication interface 430 and a system bus 440 for interconnecting each of these components in a known manner.

Communication interface 430 may receive viewer inputs via a remote control or a keyboard or other such input device 450. Interface 430 may receive data files such as AV files via an antenna 470 (if signal is broadcast/broadcast multicast for example) or over a ISP gateway/modem 480.

Interface 430 may also provide communication with a display or monitor (e.g. TV) 460 for displaying AV content. The display may have audio output for playing the audio component of an AV file. Interface 430 may also communicate data with CCC 101 of FIG. 1. The data may include viewer input. The data may also include viewer profile generated by/within STB 400. Memory 420 may store the received audiovisual data for viewing at a time chosen by the viewer.

The STB could be any reception device. It need not be limited to a typical hardware device as highlighted above. It can be any device (or software) that comprises, but not be limited to, a processor, storage, internet connection and broadcast reception. It can be a mobile phone, a tablet, a laptop, a desktop or the like. It can be an app running on any of these devices. Each of those components (or software modules) may be in a single device or in multiple devices (such as network-attached storage, etc.).

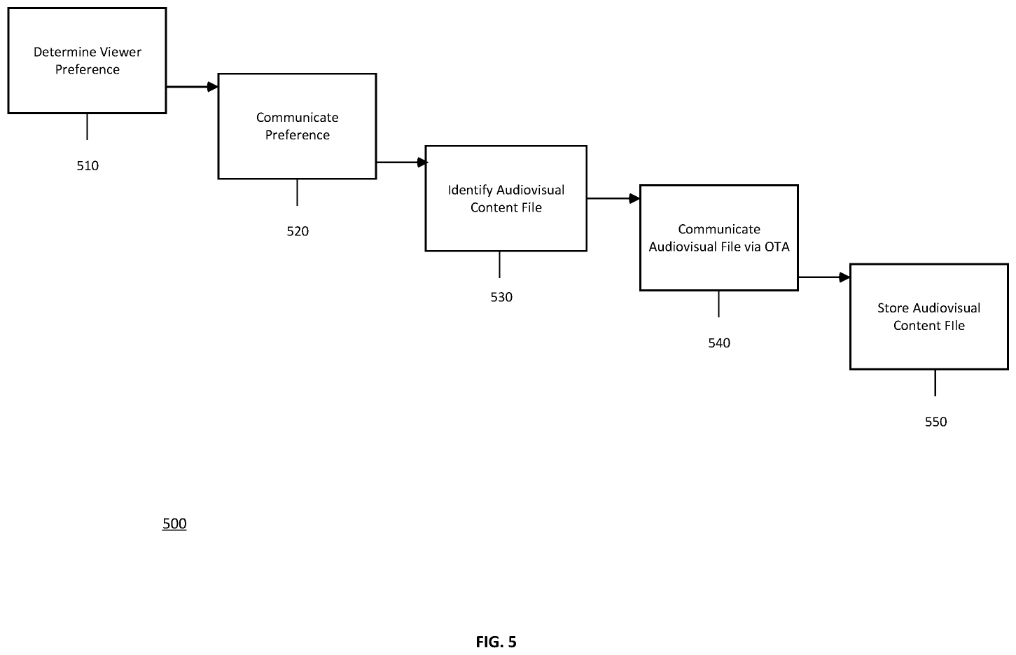

A method 500 in accordance with example embodiments is illustrated in FIG. 5. A viewer preference may be determined at 510. A viewer may identify a plurality of programs or AV content files the viewer wishes to view (a “wish list” of sorts). A list of available programs may be presented to the viewer in known manner such as based on programs viewed or by a search initiated by the viewer. The viewer may interact with a set-top-box (STB) via a remote control, a mouse, a pointing device, via voice, etc.

In some embodiments, viewer preference may be determined using predictive modeling techniques. Such techniques may identify programs based on viewer's viewing habits, for example. The set of pre-distributed content can also be targeted per viewer, using past viewing habits as a predictor for future viewing. This content can be free to the viewer, can be included in a subscription plan, can be paid for with an individual transaction or can be monetized via advertising.

In addition to stated viewer preferences or automatically predicted viewer preferences, an editor can decide what to include in a broadcast. This can be relevant at the initial stages before migration or evolution to the predictive modeling techniques.

The preferences (of a viewer) may be determined and stored in memory associated with STB 222 (of FIG. 2). Set-top-box 222 may communicate the preferences expressly indicated by the viewer or preferences determined by the predictive techniques to CCC 101 (of FIG. 1).

The preference may be communicated at 520. Data files corresponding to the communicated preference may be identified at 530. The identified data files may be communicated at 540. The communicated data files may be stored at 550. The communicated data files may be processed by software within the STB to provide an output for consumption by a user.

The stored content may be removed upon viewing of the received file or upon reaching pre-set expiration date for example. The broadcast may utilize digital sub-channels for broadcasting the identified AV content. In digital broadcasts, multiple sub-channels may be utilized within an assigned broadcast frequency spectrum. The sub-channels can be video and/or data subchannels. In terms of frequency, a channel may be allocated a 6 MHz frequency spectrum which can translate to a data transfer rate of approximately, though not limited to, for example, 40 Mbps MB/sec.

A particular sub-channel may be considered to have allocated to it a portion of that 40 Mbps, for example, 5 Mbps. Any files delivered on this subchannel would be delivered at that rate, so a 100 MB file would take 160 seconds of the broadcast stream subchannel ((100 MB*8 bits/byte)/5 Mbps). This rate could also vary with time to enable faster or slower delivery of files.

In some embodiments, CCC 101 may receive multiple preferences from one viewer, one preference from multiple viewers or multiple preferences from multiple viewers. CCC 101 may then identify a plurality of data files corresponding to the user preferences within the content generator 160. The identified data files may then be sent to the CCP corresponding to the user who expressed the preferences for broadcast in a carouseling manner.

That is, if N files are identified for broadcast, then they can be broadcast sequentially from file 1 to file N in the following sequence: 1, 2, 3, . . . , N. Upon broadcasting of N files, the process may be repeated starting with file 1 and continuing to file N. Each file may be broadcast in its entirety before the next file is broadcast.

The benefit of repeating is that an STB that misses a file (due to power outage, the tuner being in use, etc.) can receive it on the next round of the carousel.

The broadcast list may be dynamic (i.e. not static). During broadcasting of files 1 to N, other files may be added and some may be removed. If a file is added, it can be assigned file number N+1. If a file a removed, identification of the remaining files may be moved up by one (e.g. file 5 can become file 4, etc.).

In other embodiments also using the carouseling manner, a (first) portion “A” of each of files 1, 2, 3, . . . , N may be broadcast sequentially followed by a (second) portion “B” of these files (i.e. 1, 2, 3, . . . , N). This process may continue until all portions of all the files are broadcast. The entire process may repeat itself upon the broadcast of all files and portions thereof. That is, the files may be broadcast in a loop that can be repeated a pre-designated number of times over a pre-set period of time.

A large file may be broken into portions in order to, for example, start processing multiple files before the have all been received each in their entirety. Also, if a file is not received completely, it is easier to fetch the missing portion if they are organized that way in the carousel (rather than having to store the entire file all over again because a portion was missed).

Data files may be added to the list based on new preferences being received by CCC 300 (of FIG. 3 or CCC 101 of FIG. 1). Upon successful receipt of a particular file (that corresponds to a preference sent by a STB), the STB may send a receipt acknowledgement to CCC 300. If no additional unfulfilled requests for that particular file remain, the AV content file may be removed from the broadcast list.

AV content files may be broadcast in a compressed format for decompression by a STB. Only the STBs associated with users that requested a particular AV file (or based on predictive modeling) may record the file broadcast by a controller. In this regard, the broadcast may effectively operate in a broadcast-multicast manner. That is, even though an AV content file is being broadcast (available to any antenna within a service area of the broadcast source), only the STBs that requested a particular AV file may record the received file based on a manifest of desired content that has been.

STBs may also receive partial files. The STB may be turned off during a portion of the broadcast. It may be using all of its tuners for other files, broadcasts or video streams. Power outages or weather conditions may also interference with receiving the broadcast.

Every storable segment of the broadcast will have a unique identifier that associates that segment of content with the overall AV file that it is a part of. Each segment will also know the total number of segments for the file as well as what number it is in the total count. If, for example, a STB gets a partial broadcast of a file, it would know that it has segments 7-24 of AV file X and that when AV file X is broadcast again in the carousel, it only needs to store segments 1-6.

The missing file elements or remaining portions can be acquired in a following or subsequent broadcast (carouseling). If the need to have the complete file is more urgent, the remaining or incomplete portions of a file can be received over an IP unicast connection. A hybrid broadcast (OTA)/unicast (Internet) delivery model according to example embodiments ensures that all content being delivered in IP packets allows for easy reassembly if they are retrieved from different paths.

In one example scenario, if someone starts watching a movie delivered by the AV carousel has missing portions. When the player software comes across a missing segment, it can fetch it over unicast instead of waiting for the next turn of the carousel so that the viewer's movie is uninterrupted.

An audiovisual content file received by STB 400 may be stored in memory 420. If a requested or desired program is already cached on the device (i.e. STB), the content may readily be available for the viewer.

The catalog of AV content (or a manifest) may be sent to a plurality of users/viewers. The manifest may be personalized to each user based on user specified AV content, pre-determined user preferences or predictive modeling techniques. The manifest may be communicated via a unicast transmission to each user or via a multicast transmission to a plurality of users.

The AV content designated for a user may be specific to that particular user. In this case, the manifest may be communicated by the unicast transmission. A plurality of manifests each specific to a particular user may be communicated by a plurality of unicast transmissions to the plurality of viewers.

The AV content designated for a plurality of users may be identical in some cases. In this case, the manifest may be communicated by the multicast transmission to the plurality of users with the identical, designated AV content. The manifest may also be communicated by a combination of unicast and multicast transmissions.

The manifest as communicated in the manner described above may include, but need not be limited to, a user identification, identification of the AV content (or data) designated for that user and a time (or times) of transmission of the AV content. The manifest may also include the frequency or channel on which the AV content will be transmitted. The transmission may be via an OTA broadcast. The manifest may be received by the set-top box (STB) of the user and stored in the memory of the STB.

The manifest may be updated on a periodic basis or upon the occurrence of a pre-determined event. A pre-determined event may include, for example, newly specified user input (or determined user preferences or utilizing predictive modeling techniques) regarding the content that is desired by the user or is determined to be appropriate to the user. Content from a manifest may be replaced or supplemented at the set-top box by a subsequently transmitted manifest.

The processor of the set-top box may instruct the tuner to tune into the designated frequency at the designated time (as specified in the manifest) to receive and store the AV content specific to the user.

The set-top box may include a plurality of tuners. The benefits of having dedicated tuners may include faster channel change since AV streams are already “pre-tuned” as well as an ability to assume that data subchannels are always available (in order to deliver control information, emergency alerts, etc.). as well as the ability to ensure delivery of NVOD files.

A subset of the plurality of tuners may be dedicated (a priori) to receiving the AV content designated for the user (associated with the STB). In some embodiments, if N tuners are included in the STB, up to N−1 of the tuners may be pre-dedicated. A plurality of concurrently broadcast data files may be simultaneously received utilizing the plurality of tuners. A separate antenna may be associated with each of the N tuners—that is, for N tuners, N antennas may be included. In some embodiments, one antenna may be shared by multiple tuners.

The user may still use the remaining, non-dedicated tuner(s) to tune to other broadcast programming. In some embodiments, at least one tuner is available to the user; in other embodiments, no tuners may be available to the user. The tuner can be utilized to receive video, audio, data and livestreams in example embodiments. In existing systems such as cable and satellite, the format of transmitted data is medium specific.

In example embodiments in which the number of dedicated tuners is N−1, the manifest need not include time of broadcast and frequency on which broadcast takes place. These two values (time and frequency) are not needed as a (dedicated) tuner is tuned (constantly) to its corresponding frequency and can recognize the content. The received content is recognized based on matching the program or content identification (ID) specified in the manifest with the program or content ID embedded within the broadcast content (or in the content communicated via broadband). Such received content can then be stored in the memory of the set-top box. By dedicating tuners to a particular frequency, the broadcaster can ensure that particular AV content files or other data files will be delivered to the set-top box since the tuner is tuned to the broadcaster's frequency at all times.

In example embodiments in which the number of (dedicated) tuners is less than N−1, the time and frequency may be included in the manifest. If, for example, the number of channels on which data files are being broadcasts is five (5) and the set-top box has three (3) tuners. One of these tuners may be available to the user. In this case, only two (2) tuners are available to receive/process as many as four (4) data streams. Each of the two (2) tuners may not be dedicated to a particular frequency.

In such a scenario, each of the two (2) tuners can tune into a respective, specified broadcast frequency based on the time of broadcast specified in the manifest for a particular content stream. Each of these two (2) tuners can be dynamically allocated to frequencies based on the content stream that is desired to be received and stored.

Other example embodiments can include a combination of that described above. For example, in the case of having less than N−1 tuners being dedicated, one of the two tuners (2) can be dedicated to one frequency while the remaining tuner can be dynamically instructed to tune into a specified frequency.

The type of broadcast data is not limited to AV files. It can also include, but is not limited to, text, user manuals and interactive tutorials in some example embodiments. Other examples may include software applications, textbooks, commands to control the set-top box, emergence alerts, notification, sports scores, news headlines, stock tickers, etc. The terms “data stream”, “broadcast content”, “AV content”, data files are used interchangeably.

Using broadcast distribution technologies, the content distributor can rotate what content is available for broadcasting using a carouseling technique. The various devices that consume content can then receive, record and store that content as it is broadcast. Over time, each device will collect the full set of broadcasted content based on user preferences, and as included in the manifest.

This may necessitate a catalog of content to be sent ahead of time to a STB so that it (the STB) knows what content should be on its local storage and can keep track of what has been stored and what has not been stored. This catalog can be targeted and personalized per user.

If the full catalog of content (i.e. a manifest) may take a significant amount of time to be fully downloaded, and if most of the content has been downloaded and some key parts have not, the STB can locate and fill in the missing parts of its catalog via unicast delivery of content (instead of waiting for the content to arrive via the broadcast carousel). This can be done at a time of day when unicast delivery is less expensive.

According to example embodiments, the missing parts can be sent to the STB via broadband without altering the format of the data (i.e. IP) that is also or has also been sent via OTA broadcast.

As an example, a movie delivered using MPEG-DASH may consist of a set of numbered segments of H.265 encoded video. The STB may receive all but segment numbers 7, 13, and 27. During playback, the AV player software detects that #7 is missing when playing #5 and downloads #7 via unicast so that at the conclusion of playing segment #6, it can play #7. Since the segments are the same whether delivered via OTA broadcast or Internet unicast, they are compatible with each other.

The AV content that is broadcast and cached at a viewer premises may be broadcast at different speeds. It can be broadcast at a higher speed by increasing the bandwidth that is allocated for broadcast. The file size of an encoded video file can be decreased. This can be accomplished by utilizing a more effective codec compression such as going from H.264 to HEVC/H.265 or by reducing the bitrate that the file is encoded; that is, decreasing the quality by reducing the amount of space that each frame of the video takes up or by reducing the resolution of the video file (from 4K to 1080p or 720p). A number of techniques can be combined to reduce the file size even further.

In this scenario, an AV file that might be 30 minutes in duration for viewing may be broadcast in less than that time (i.e. <30 minutes).

A smaller file (with a constant bandwidth) can be transmitted at a faster rate. Conversely, a larger file (with a constant bandwidth) can be transmitted at a slower rate.

An AV file may be broadcast at a lower speed by decreasing the bandwidth allocated for the broadcast. It can also be reduced by increasing the resolution. In this scenario, an AV file that might be 30 minutes in duration for viewing may be broadcast in more than that time (i.e. >30 minutes).

The 40 MB/Sec data transfer rate may facilitate simultaneous broadcast of multiple data streams each having potentially different transfer rates. As an example, a breaking news story may have to delivered in a rapid manner while a classis sporting event from the past can be delivered in a slower manner. The delivery is not limited to video—data used to control the STB can be delivered faster and more frequently, for example.

According to example embodiments, user preferences may be utilized to generate a manifest by a CCC. The CCC may receive the preferences over a broadband connection from one or more set-top boxes each associated with a user. The manifest may be sent to the users (corresponding to the preferences) via the broadband connection.

As highlighted above, the contents of the manifest may include identification of programs or data files corresponding to the preferences that are to be broadcast over the air as data files. In some embodiments, the manifest may also include a time and frequency at which the data files are to be broadcast over the air.

The set-top may use one or more associated tuners to “await” the broadcast identified in the manifest and may record the data files that are broadcast. The files may be converted and stored or may be stored and then converted for “consumption” by a user. In some embodiments, the manifest may be encrypted; the data files broadcast may also be encrypted. The set-tope box may decrypt the manifest and the data files.

Although example embodiments have been disclosed, it will be apparent to those skilled in the art that various changes and modifications can be made which will achieve some of the advantages of embodiments without departing from the spirit and scope of the disclosure. Such modifications are intended to be covered by the appended claims.

Further, in the description and the appended claims the meaning of “comprising” is not to be understood as excluding other elements or steps. Further, “a” or “an” does not exclude a plurality, and a single unit may fulfill the functions of several means recited in the claims.

The above description of illustrated embodiments and what is described in the Abstract below, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in relevant art.

The various embodiments described above can be combined to provide further embodiments. Aspects of the embodiments can be modified, if necessary, to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method of communicating audiovisual (AV) content to a viewer, the method comprising the steps of:
determining viewing preferences associated with a viewer;
communicating the preferences to a content controller;
identifying data files corresponding to the preferences by the content controller;
communicating, by the content controller, a manifest to the user wherein the manifest identifies the data files that are to be broadcast over the air;
receiving, by a tuner associated with the user, the broadcast data files; and
storing, by a set-top box associated with the tuner, the received broadcast data files.
